(19) United States
(12) Patent Application Publication
(10) Pub. No.: US 2017/0276878 A1
(43) Pub. Date: Sep. 28, 2017

(54) POINT-SYMMETRIC MACH-ZEHNDER-INTERFEROMETER DEVICE

(71) Applicant: Huawei Technologies Co., Ltd., Shenzhen (CN)

(72) Inventors: Youfang Hu, Gent (BE); Ulagalandha Perumal Dharanipathy, Gent (BE)

(21) Appl. No.: 15/465,288

(22) Filed: Mar. 21, 2017

(30) Foreign Application Priority Data
Mar. 22, 2016 (EP) 16161719.6

(51) Int. Cl. G02B 6/293; G02B 6/28; G02B 6/122; G02B 6/12

(52) U.S. Cl. CPC G02B 6/29352; G02B 6/2938; G02B 6/12007; G02B 6/2861; G02B 6/122; G02B 2006/12038

(57) ABSTRACT

The present invention provides a Point-Symmetric Mach-Zehnder-Interferometer (PSMZI) device, comprising three consecutive path delay sections (PDSs) provided as two outer PDS and one center PDS, each PDS including an upper waveguide arm and a lower waveguide arm. The PSMZI device also includes four asymmetric couplers (ACs) each AC including an upper waveguide portion and a lower waveguide portion. One AC is arranged directly on each side of each PDS, the upper and lower waveguide portions being respectively coupled to the upper and lower waveguide arms. Further, the AC on the one side of the PDS is point-symmetric to the AC on the other side of the PDS, and the two ACs and the one outer PDS arranged on the one side of the center PDS are together point-symmetric to the two ACs and the one outer PDS arranged on the other side of the center PDS.

### CROSS-REFERENCE TO RELATED APPLICATION

This application claims priority to European Patent Application No. EP16161719.6, filed on Mar. 22, 2016, which is hereby incorporated by reference in its entirety.

### TECHNICAL FIELD

The present invention relates to a Point-Symmetric Mach-Zehnder-Interferometer (PSMZI) device, to a wavelength duplexer device including the PSMZI device, and to a fabrication method of the PSMZI device.

### BACKGROUND

Silicon photonics is rapidly gaining importance as a generic technology platform for a wide range of applications in telecom, datacom, interconnect, and sensing. Silicon photonics allows implementing photonic functions through the use of CMOS compatible wafer-scale technologies on high quality, low cost silicon substrates. However, pure passive silicon waveguide devices still have limited performance in terms of insertion loss, phase noise (which results in channel cross-talk) and temperature dependency. This is due to the high refractive index contrast between the SiO₂ (silicon dioxide) cladding and the Si (silicon) core, the non-uniform Si layer thickness, and the large thermo-optical effect of silicon.

SiNₓ (silicon nitride) based passive devices offer superior performance. Propagation losses below 0.1 dB/cm have been demonstrated for waveguides with a 640 nm thick SiNx core, and even below 0.1 dB/m for waveguides with a 50 nm thick core. Also, the slightly lower refractive index contrast between SiNₓ (n=2) and SiO₂ (n=1.45) versus Si(n=3.5) and SiO₂ (n=1.45) results in less phase noise and larger fabrication tolerances. This makes the fabrication of high performance, but still very compact optical circuits, such as AWGs or ring resonators, possible. SiNₓ waveguides have been reported both as a high performance passive waveguide layer on an active silicon photonics chip, and also as ‘stand-alone’ passive optical chips.

In Fiber-To-The-X (FTTX) devices/equipment, e.g. OLT, ONU, it is known to use a wavelength duplexer for separating upstream and downstream wavelength bands from a single input optical fiber. ITU standards require wavelength duplexing with low insertion loss and low cross-talk over broad wavelength bands, in order to be realized at low cost. The use of a (silicon) photonic integrated circuit (PIC) in FTTX devices/equipment has the advantages of low cost, small size and high reliability.

For realizing, for instance, a PIC duplexer, it is known to employ Multimode Interferometers (MMIs), Mach-Zehnder-Interferometers (MZIs), rings etc. based on silicon photonics. For all these structures, however, it is still challenging to achieve the ITU-specified performance along with a high yield in mass production. Also Multi-stage cascaded MZI have been used in a broadband duplexer. The flatness of the filter's pass-band and isolation between channels increases, when the number of cascading stages increases. However, at the same time the complications of the photonic circuits and the sensitivity to fabrication errors also increases with the number of stages.

Hida et al. (‘Journal of Lightwave Technology, Vol. 14, No. 10, pp. 2301-2310, 1996’ and ‘Electronics and Communications in Japan, Part 2, Vol. 81, No. 4, pp. 19-28, 1998’) proposed silica-based PSMZIs for a broadband flat-top wavelength (de)multiplexer. The design is based on a zero-arm-difference MZI with two coupler sections formed by two identical coupler MZIs. The coupler MZIs are realized by symmetric (directional) couplers (SCs). In such SCs the spectral response of a coupling coefficient K(λ) varies periodically between 0 and 1. The coupling coefficient K(λ), and its sensitivity to structural parameter variations, temperature changes etc., can be shaped by designing structural parameters of the SC. For instance, a gap distance, coupler waveguide width, coupler waveguide length, bending waveguide width, taper length, waveguide thickness, or waveguide etching thickness can be selected.

Takagi et al. (‘Journal of Lightwave Technology, Vol. 10, No. 12, pp. 1814-1824, 1992’) proposed three types of silica-based asymmetric (directional) couplers (ACs) with series-tapered coupling structures, namely, line-symmetric series-tapered (LSST), point-symmetric series-tapered (PSST), and non-symmetric series-tapered (NSST), respectively. These ACs were only designed for wavelength-insensitive coupling (WINO).

So far, ACs are not known for use in PSMZIs. This is due to the fact that still low refractive index contrast platforms dominate the fabrication of PICs, in which the use of ACs increases the fabrication cost of a PSMZI device substantially compared with SCs.

### SUMMARY

The present invention aims to further improve conventional PSMZIs. In particular, the present invention has the object to provide a PSMZI device with improved performance and less sensitivity to fabrication errors. To this end, the present invention aims for a PSMZI device, which provides more design flexibility. Additionally, a substantial reduction of production costs of a PSMZI device, and also of FTTX modules, e.g., of OLT and ONU, is to be achieved.

One object of the present invention is achieved by the solution provided in the enclosed independent claims. Advantageous implementations of the present invention are further defined in the dependent claims. Essentially, the present invention proposes the use of ACs in a PSMZI device.

A first aspect of the present invention provides a PSMZI device, comprising three consecutive path delay sections (PDSs), provided as two outer PDS and one center PDS, each PDS including an upper waveguide arm and a lower waveguide aim, four ACs, each AC including an upper waveguide portion and a lower waveguide portion, wherein one AC is arranged directly on each side of each PDS, the upper and lower waveguide portions being respectively coupled to the upper and lower waveguide aims, wherein the AC on the one side of the PDS is point-symmetric to the AC on the other side of the PDS, and wherein the two ACs and the one outer PDS arranged on the one side of the center PDS are together point-symmetric to the two couplers and the one outer PDS arranged on the other side of the center PDS.

In a typical AC, the ratio of an effective coupling length to a total length is smaller than 1, in contrast with a SC, in which this ratio equals to 1. An AC is further characterized by the fact that the phase difference between its cross- and through-output is potentially not 90°. By providing the point-symmetric arrangement of the ACs in the PSMZI device of the first aspect, the shape and geometry of the asymmetries is reversed on either side of each PDS, and on either side of the central PDS. Accordingly, any phase deviation coming from a single AC is compensated. As a consequence, the PSMZI device of the first aspect benefits fully from the larger design flexibility that an AC brings, without any drawbacks.

In particular, by the use of the ACs in the PSMZI device of the first aspect, more design flexibility is introduced, because there are extra design parameters (e.g. a coupling waveguide width difference) in addition to the design parameters also provided by SCs. The extra design parameters of the ACs can be used for shaping the spectral response of the couplers within the PSMZI device. With the additional degree of freedom in designing the couplers, a better overall performance can be achieved. Specifically, a spectral response of each AC can be shaped to be closer to the optimal design than a spectral response of a comparable SC. This is particularly true for couplers designed for a broadband, flat-top, low-cross-talk duplexer.

In the PSMZI device of the first aspect, because any pair of ACs on either side of each PDS is point symmetric, dimensional errors occurring during the fabrication process of the PSMZI device will likewise occur in all ACs. This is due to the fact that all AC structures are located relatively close to each other during the fabrication process. Thus, any dimensional errors will compensate each other.

In a first implementation form of the device according to the first aspect, the center PDS provides a path difference of zero.

Accordingly, a completely point-symmetric structure can be designed for the PSMZI device.

In a second implementation form of the device according to the first aspect as such or according to the first implementation form of the first aspect, a path difference provided by one outer PDS is the same, but is provided in the other waveguide arm, than a path difference provided by the other outer PDS.

In a third implementation form of the device according to the first aspect as such or according to any one of the previous implementation forms of the first aspect, a total path length of all upper waveguide aims is the same as a total path length of all lower waveguide arms.

Accordingly, the complete structure of the PSMZI device becomes fully point-symmetric.

In a fourth implementation form of the device according to the first aspect as such or according to any of the previous implementation forms of the first aspect, the four ACs and the two outer PDS are designed such that a phase difference, which is caused by the two ACs and one outer PDS arranged on the one side of the center PDS, is compensated by a phase difference, which is caused by the two ACs and one outer PDS arranged on the other side of the center PDS.

As a consequence, the increased design flexibility provided by the ACs can be fully exploited in the design of the PSMZI device without any negative impacts on its performance.

In a fifth implementation form of the device according to the first aspect as such or according to any of the previous implementation forms of the first aspect, the four ACs are of the line-symmetric series-tapered (LSST) type.

The preferred LSST type used in the PSMZI device of the first aspect yields the best coupling results, and thus the largest performance improvements.

In a sixth implementation form of the device according to the first aspect as such or according to any of the previous implementation forms of the first aspect, the waveguide arms are made of a material having a refractive index in a range of 1.4-4.5.

In a seventh implementation form of the device according to the first aspect as such or according to any of the previous implementation forms of the first aspect, the waveguide arms are made of SiN, and are more particularly embedded into a cladding made of SiO₂.

Accordingly, a high refractive index contrast platform is preferred. This is due to the fact that in low refractive index contrast platforms, (directional) couplers are always weakly coupled (since a waveguide gap is a few μm), and thus the whole structure needs to be very long (at least a few mm), in order to achieve the desired coupling characteristics. However, in high refractive index contrast platforms, more particularly with SOI or SiN-on-Silica, the (directional) couplers can be designed to be more strongly coupled (with a waveguide gap being 200-400 nm), so that the total length of the structure can be reduced to below 100 μm. This saves a lot of mask area and silicon real-estate cost in fabrication.

Each AC can specifically be designed to have a dedicated, more particularly a curved (i.e. not flat-band), coupling coefficient. This may particularly be achieved by changing the coupling waveguide width in the order of tens of nm. Such a fine adjustment is, however, not realistic to achieve in a fabrication process with coarse lithographic accuracy (e.g. a 500 nm lithography accuracy is used for fabricating MEMS). However, as the fabrication technology of high refractive index contrast platforms (e.g. CMOS having a lithography accuracy of below 100 nm) improves for PIC fabrication, the use of ACs becomes more and more practical.

In an eighth implementation form of the device according to the first aspect as such or according to any of the previous implementation forms of the first aspect, the PSMZI device further comprises an even number of additional PDS provided on either side of and point-symmetrically to the center PDS, each additional PDS including an upper waveguide atm and a lower waveguide aim, and an even number of additional ACs or symmetric couplers (SCs) each additional AC or SC including an upper waveguide portion and a lower waveguide portion, wherein one AC or SC is arranged directly on each side of each additional PDS, the upper and lower waveguide portions being respectively coupled to the upper and lower waveguide arms, and wherein the AC or SC on the one side of the additional PDS is point-symmetric to the AC or SC on the other side of the additional PDS.

Accordingly, a multi-stage PSMZI device in line with the invention can be fabricated. As mentioned above, the flatness of the filter's pass-band and an isolation between channels increases, when the number of cascading stages increases. The previously negative consequence of an increased sensitivity to fabrication errors with an increasing number of stages, is compensated—at least to some extent—by the use and advantages of the ACs.

In a ninth implementation form of the device according to the first aspect as such or according to any of the previous implementation forms of the first aspect, a width of each waveguide arm in each AC is between 1-3 μm, more particularly between 1.5-2 μm.

In a tenth implementation form of the device according to the first aspect as such or according to any of the previous implementation forms of the first aspect, a width variation of each waveguide arm in each AC is between 10-1000 nm, more particularly between 20-200 nm.

In an eleventh implementation form of the device according to the first aspect as such or according to any of the previous implementation forms of the first aspect, a distance between the waveguide arms in each AC is between 0.25-0.5 μm, more particularly between 0.3-0.4 μm.

The above-mentioned parameters are all optimized for an improved performance of the PSMZI device on the one hand side, and for a reduced sensitivity to fabrication errors on the other hand side.

In a twelfth implementation form of the device according to the first aspect as such or according to any of the previous implementation forms of the first aspect, the PSMZI device includes two coupler Mach Zehnder Interferometers (MZIs) arranged in a point symmetric way, and coupling coefficients CW of each coupler MZI satisfy C=0.5 at a peak transmission wavelength of a cross-port of the coupler MZI, C=0 or C=1 at a peak transmission wavelength of a through-port of the coupler MZI, and dC/dλ=0 at the peak transmission wavelength of the cross-port.

By selecting the coupling coefficients in the above manner, a spectral response that is optimized for broadband, flat-top, and low-cross-talk is achieved.

A second aspect of the present invention provides a wavelength duplexer device comprising at least one PSMZI device according to the first aspect as such or according to any of the previous implementation forms of the first aspect, wherein the wavelength duplexer device is more particularly configured for use in a passive optical network (PON) related application.

By using the PSMZI device of the first aspect, a wavelength duplexer with both low insertion loss and low TX to RX cross-talk at the TX wavelength band is obtained.

A third aspect of the present invention provides a method of fabricating a PSMZI device, comprising the steps of: providing three consecutive PDSs as two outer PDS and one center PDS, each PDS including an upper waveguide arm and a lower waveguide arm, providing four ACs, each AC including an upper waveguide portion and a lower waveguide portion, wherein one AC is arranged directly on each side of each PDS, the upper and lower waveguide portions being respectively coupled to the upper and lower waveguide arms, wherein the AC on the one side of the PDS is point-symmetric to the AC on the other side of the PDS, and wherein the two ACs and the one outer PDS arranged on the one side of the center PDS are together point-symmetric to the two couplers and the one outer PDS arranged on the other side of the center PDS.

In a first implementation form of the method according to the third aspect, the center PDS provides a path difference of zero.

In a second implementation form of the method according to the third aspect as such or according to the first implementation foil of the third aspect, a path difference provided by one outer PDS is the same, but is provided in the other waveguide aim, than a path difference provided by the other outer PDS.

In a third implementation foil of the method according to the third aspect as such or according to any one of the previous implementation forms of the third aspect, a total path length of all upper waveguide arms is the same as a total path length of all lower waveguide aims.

In a fourth implementation form of the method according to the third aspect as such or according to any of the previous implementation forms of the third aspect, the four ACs and the two outer PDS are designed such that a phase difference, which is caused by the two ACs and one outer PDS arranged on the one side of the center PDS, is compensated by a phase difference, which is caused by the two ACs and one outer PDS arranged on the other side of the center PDS.

In a fifth implementation form of the method according to the third aspect as such or according to any of the previous implementation forms of the third aspect, the four ACs are of the LSST type.

In a sixth implementation form of the method according to the third aspect as such or according to any of the previous implementation forms of the third aspect, the waveguide arms are made of a material having a refractive index in a range of 1.4-4.5.

In a seventh implementation form of the method according to the third aspect as such or according to any of the previous implementation forms of the third aspect, the waveguide arms are made of SiN, and are more particularly embedded into a cladding made of SiO₂.

In an eighth implementation form of the method according to the third aspect as such or according to any of the previous implementation forms of the third aspect, the PSMZI device further comprises an even number of additional PDS provided on either side of and point-symmetrically to the center PDS, each additional PDS including an upper waveguide atm and a lower waveguide arm, and an even number of additional ACs or SCs, each additional AC or SC including an upper waveguide portion and a lower waveguide portion, wherein one AC or SC is arranged directly on each side of each additional PDS, the upper and lower waveguide portions being respectively coupled to the upper and lower waveguide aims, and wherein the AC or SC on the one side of the additional PDS is point-symmetric to the AC or SC on the other side of the additional PDS.

In a ninth implementation form of the method according to the third aspect as such or according to any of the previous implementation forms of the third aspect, a width of each waveguide aim in each AC is between 1-3 μm, more particularly between 1.5-2 μm.

In a tenth implementation form of the method according to the third aspect as such or according to any of the previous implementation forms of the third aspect, a width variation of each waveguide aim in each AC is between 10-1000 nm, more particularly between 20-200 nm.

In an eleventh implementation form of the method according to the third aspect as such or according to any of the previous implementation forms of the third aspect, a distance between the waveguide arms in each AC is between 0.25-0.5 μm, more particularly between 0.3-0.4 μm

In a twelfth implementation form of the method according to the third aspect as such or according to any of the previous implementation forms of the third aspect, the PSMZI device includes two coupler MZIs arranged in a point symmetric way, and coupling coefficients C(λ) of each coupler MZI satisfy C=0.5 at a peak transmission wavelength of a cross-port of the coupler MZI, C=0 or C=1 at a peak transmission wavelength of a through-port of the coupler MZI, and dC/dλ=0 at the peak transmission wavelength of the cross-port.

With the fabrication method according to the third aspect, a PSMZI device with all advantages over a conventional PSMZI device mentioned-above regarding the first aspect is achieved.

It has to be noted that all devices, elements, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be full formed by eternal entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF THE DRAWINGS

The above described aspects and implementation forms of the present invention will be explained in the following description of specific embodiments in relation to the enclosed drawings, in which:

FIG. 1 shows a PSMZI device according to an embodiment of the present invention;

FIG. 2 shows a PSMZI device according to an embodiment of the present invention;

FIG. 3 shows a PSMZI device according to an embodiment of the present invention;

FIG. 4 shows coupling in a coupler MZI device according to an embodiment of the present invention;

FIG. 5 shows an AC of the LSST type, as used in a PSMZI device according to an embodiment of the present invention;

FIG. 6(a) and FIG. 6(b) show simulation results for a PSMZI device according to an embodiment of the present invention;

FIG. 7(a) and FIG. 7(b) and FIG. 7(c) and FIG. 7(d) show simulation results for a PSMZI device according to an embodiment of the present invention;

FIG. 8(a) and FIG. 8(b) show simulation results for a PSMZI device according to an embodiment of the present invention;

FIG. 9(a) and FIG. 9(b) and FIG. 9(c) and FIG. 9(d) show simulation results for a PSMZI device according to an embodiment of the present invention; and

FIG. 10 shows a flow-diagram of a fabrication method according to an embodiment of the present invention.

### DETAILED DESCRIPTION

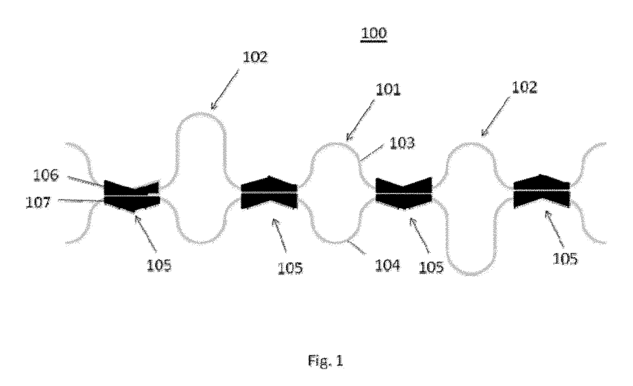

FIG. 1 illustrates schematically a PSMZI device 100 according to an embodiment of the present invention. As can be seen, the PSMZI device 100 comprises at least three consecutive PDSs 101, 102. In particular, the three PDSs 101, 102 are provided—in an extension direction of the PSMZI device 100 (i.e., from left to right in FIG. 1)—as a first outer PDS 102, a center PDS 101, and a second outer PDS 102 located on the other side of the center PDS 101 than the first outer PDS 102. Each PDS 101, 102 includes an upper waveguide arm 103 and a lower waveguide aim 104. The waveguide arms 103, 104 are more particularly made of a material having a refractive index in a range of 1.4-4.5. Advantageously, the waveguide arms 103, 104 may be made in a high refractive index contrast platform, more particularly are made of SiNₓ, and are optionally embedded into a cladding made of SiO₂.

The PSMZI device 100 further comprises at least four ACs 105 (schematically illustrated in FIG. 1), provided alternatingly with the PDSs 101, 102. In particular, one AC 105 is arranged directly on each side of each PDS 101, 102. That means in the extension direction of the PSMZI device 100 (i.e., from left to right in FIG. 1)—at least a first AC 105, the first outer PDS 102, a second AC 105, the center PDS 103, a third AC 104, the second outer PDS 102, and a fourth AC 105 are consecutively arranged.

Each AC 105 includes an upper waveguide portion 106 and a lower waveguide portion 107 (only schematically illustrated in FIG. 1), and the upper and lower waveguide portions 106, 107 of an AC 105 are respectively coupled to the upper and lower waveguide arms 103, 104 of each neighboring PDS 101, 102. The four ACs 105 may advantageously be all of the LSST type.

In the PSMZI device 100, the AC 105 on the one side of each PDS 101, 102 is point-symmetric to the AC 105 on the other side of the PDS 101, 102. That means particularly, that the shape and asymmetry of the two ACs 105 around each PDS 101, 102 are inverted with respect to each other. Furthermore, the two ACs 105 and the first outer PDS 101 arranged on the one side of the center PDS 102 are together point-symmetric to the two ACs 105 and the second outer PDS 101 arranged on the other side of the center PDS 102. That means, for instance, that a path difference provided by the first outer PDS 102 is the same, but is provided in a different waveguide arm 103 than a path difference provided by the second outer PDS 102 (which is provided in the other waveguide arm 104).

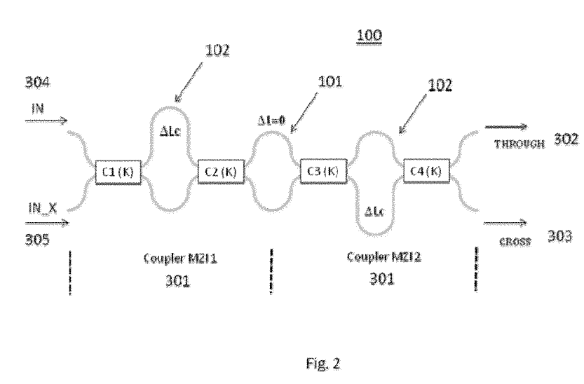

FIG. 2 shows a more detailed embodiment of the PSMZI device 100 of FIG. 1. It can be seen that the PSMZI device 100 includes at least one IN port 304, IN_X port 305, THROUGH port 302 and CROSS port 303. Further, the PSMZI device 100 includes two coupler MZIs 301, which arranged in a point-symmetric way in respect to the central PDS 102. The first coupler MZI 301 includes the first outer PDS 102 and two of the ACs 105. The second coupler MZI 301 includes the second outer PDS 102 and the other two of the ACSs 105.

The structure of the PSMZI device 100 may be advantageously globally point-symmetric with the following characteristics:
The path length from the IN port 304 to the THROUGH port 302 may optionally be the same as the total path length from the IN_X port 305 to the CROSS port 303.
The path length difference ΔL in the center PDS 101 section is optionally zero (ΔL=0). That is, the center PDS 101 provides a path difference ΔL of zero.
Optionally, a path difference ΔLc provided by the first outer PDS 102 is the same, but is provided in the other waveguide atm 103, 104, than a path difference provided by the second outer PDS 101.
A total path length of all upper waveguide arms 103 may optionally be the same as a total path length of all lower waveguide arms 104.
Advantageously there may be the same number of couplers on either side of the center PDS 101. In other words, the total structure may optionally have an even number, and specifically at least four, ACs 105.

Accordingly, also the coupler MZIs 301 on either side of the center PDS 102 are arranged in a point-symmetric layout.

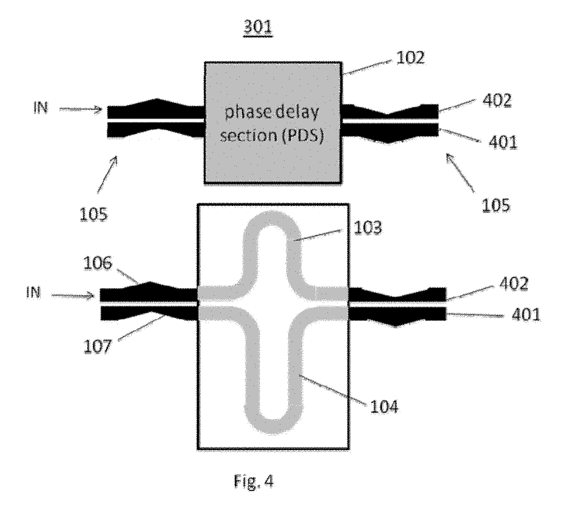

Furthermore, the single MZIs 301 on either side of the central PDS 101 can be replaced with multiple-stage cascaded MZIs 301 (not shown). That means, the PSMZI device 100 may further comprise an even number of additional PDS on either side of and point-symmetrically to the center PDS 101, and an even number of additional ACs or SCs arranged directly on each side of each additional PDS. Thereby, the AC or SC on the one side of each additional PDS may be point-symmetric to the AC or SC on the other side of the additional PDS. Further, as shown in FIG. 4, each additional AC or SC includes—as each AC 105 of FIG. 2—an upper waveguide portion and a lower waveguide portion, and each additional PDS includes—as each PDS 101, 102 of FIG. 2—an upper waveguide arm and a lower waveguide arm. The upper and lower waveguide portions of the (directional) couplers are respectively coupled to the upper and lower waveguide arms of the PDS.

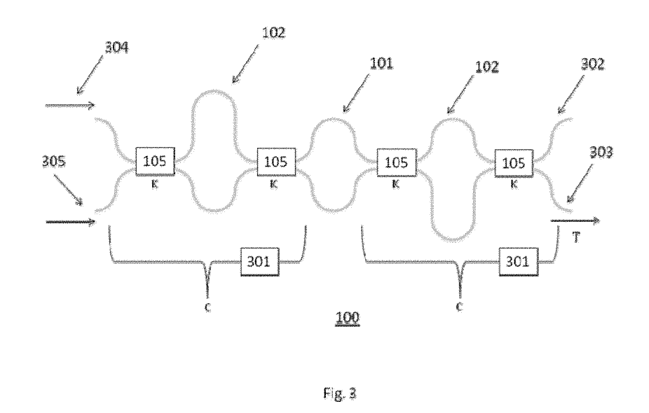

As shown in FIGS. 2 and 3, the individual ACs 105 (labelled as C1-C4 in FIG. 3) have a coupling coefficient K(λ), and are arranged in a fully point-symmetric way. The ACs 105 may advantageously be designed to have a coupling coefficient K(λ) that comes as close as possible to the optimal design (i.e. the optimal coupling coefficient). Thereby, the improved designing is supported by the additional design flexibility granted by the ACs 105.

FIG. 4 shows in the upper part schematically a coupler MZI 301 with a CROSS port 401 and a THROUGH port 402. In particular, FIG. 4 shows, how the shape and geometry of the ACs 105 are reversed on either side of a PDS 101, 102 in the coupler MZI 301. Due to this reversal, a phase deviation caused by each single AC 105 is compensated by another AC 105. Therefore, in summary no phase deviation is introduced, while it is possible to benefit fully from the design flexibility that the ACs 105 provide.

FIG. 4 shows, how the coupling between ACs 105 and PDS 101, 102, respectively (which is only shown schematically in FIG. 1), is implemented in detail. In particular, coupling between two ACs 105 and one of the outer PDS 101 is shown in FIG. 4. It can be seen that the upper waveguide portions 106 of the ACs 105 are connected to opposite sides of the upper waveguide aim 103 of the PDS 101. Likewise, the lower waveguide portions 107 of the ACs 105 are connected to opposite sides of the lower waveguide aim 104 of the PDS 101. The coupling is implemented identically for all the ACs 105 and PDSs 101, 102, respectively, of the PSMZI device 100 that is shown in FIG. 1.

Optionally, as also shown in FIG. 4, each coupler MZI 301 has the same coupling coefficient C(λ) at the CROSS port 401, which is given by:

C=4K(1−K)cos²(πn_{eff}ΔLc/λ)

Further, the whole PSMZI device 100 has a coupling coefficient T(λ) at the CROSS port 303, which is given by:

T=4C(1−C)

For an optimal design, particularly for a broadband, flat-top, low-cross-talk spectral response of T(λ), the coupling coefficient C(λ) of each coupler MZI 301 may advantageously satisfy C=0.5 at a peak transmission wavelength of the CROSS port 401, C=0 or C=1 at a peak transmission wavelength of a THROUGH port 402, and dC/dλ=0 at the peak transmission wavelength of the CROSS port 401.

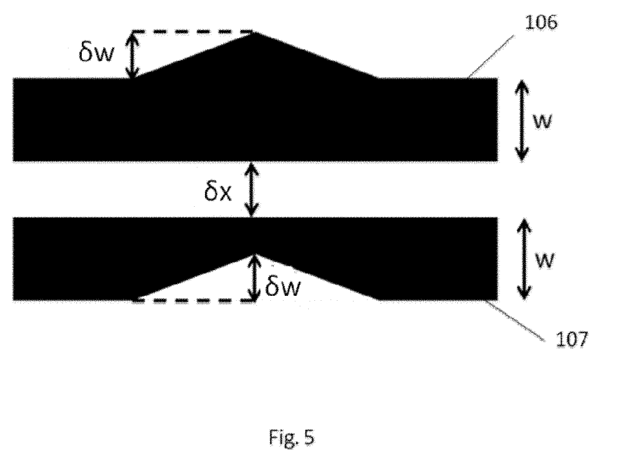

In order to fully exploit the increased design flexibility, which the use of ACs 105 in the PSMZI device 100 provides, the structural parameters ‘coupler waveguide width (w)’, ‘waveguide width difference (δw)’, and ‘gap width (δx)’ are advantageously selected. An AC 105 of the LSST type is shown as an example in FIG. 5, and the above-mentioned parameters w, δw and δx are indicated. That is, w is the basic width of the waveguide portions 106 and 107 (without taking into account asymmetries). Further, δx is the distance between the waveguide portions 106 and 107. Finally, δw is the difference caused by the asymmetries in comparison with the basic width w in each waveguide portion 106, 107. These three parameters can particularly be optimized to achieve a coupling coefficient K(λ) of the AC 105 that is as close as possible to the optimal coupling coefficient K.

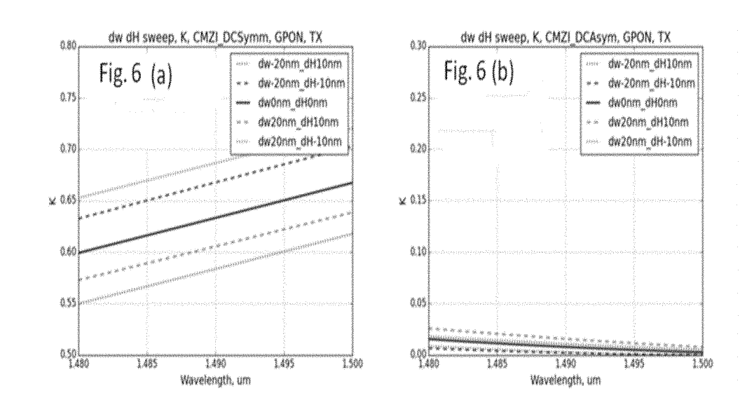

FIG. 6(a) and FIG. 6(b) show the simulated coupling coefficient K over the TX wavelength band of (a) a single DC, and (b) a single AC 105 used in a PSMZI device 100 for a GPON duplexer application.

FIG. 6 also shows the fabrication tolerances of the PMSZI device 100 regarding waveguide width (dw) and height (dH). The solid curves correspond to the target design. The dotted lines correspond to a SC with a waveguide width error of dw=−20 nm and a waveguide height error of dH=10 nm, and respectively with dw=20 nm and dH=−10 nm. The dashed lines correspond to dw=−20 nm and dH=−10 nm, and respectively to dw=20 nm and dH=10 nm.

Ideally, K should be equal to 0 or 1 at a wavelength of 1.49 μm (i.e. the GPON TX band central wavelength). The comparison between the FIGS. 6 (a) and (b) demonstrates that the ACs 105 can be designed to have a coupling coefficient K with a value much closer to the ideal design compared to the SC, with at the same time a lower sensitivity to the waveguide dimension errors (dw, dH) at TX band.

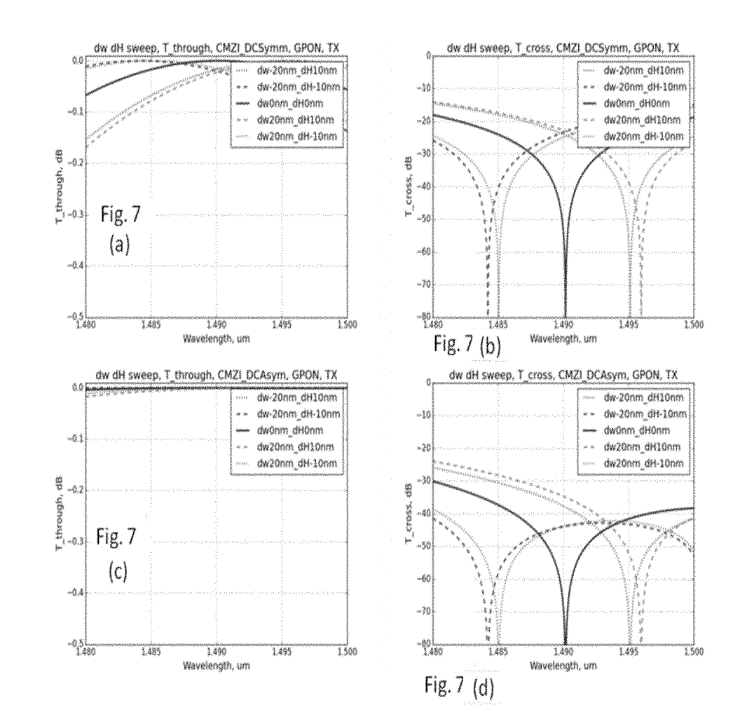

FIG. 7(a) and FIG. 7(b) and FIG. 7(c) and FIG. 7(d) show simulated CROSS/THROUGH port transmission spectra of a PSMZI device using SCs and of a PSMZI device 100 using ACs 105 at the GPON TX wavelength band. Specifically, FIG. 7 (a) relates to the THROUGH port (TX insertion loss) with SCs. FIG. 7 (b) relates to the CROSS port (TX to RX cross talk) with SCs. FIG. 7 (c) relates to the THROUGH port 302 (TX insertion loss) with ACs 105. FIG. 7 (d) relates to the CROSS port 303 (TX to RX cross talk) with ACs 105.

FIG. 7(a) and FIG. 7(b) and FIG. 7(c) and FIG. 7(d) show again fabrication tolerances in respect to waveguide width (dw) and height (dH). The solid curves correspond to the target design. The dotted lines correspond to couplers with a waveguide width error of dw=−20 nm and a waveguide height error of dH=10 nm, and respectively with dw=20 nm and dH=−10 nm. The dashed lines correspond to couplers with dw=−20 nm and dH=−10 nm, and respectively with dw=20 nm and dH=10 nm.

The comparison between FIGS. 7 (a) and (c) shows that a PSMZI device 100 using ACs 105 can be designed to have lower insertion loss with a better fabrication tolerance at the TX band compared to a PSMZI device with SCs. The comparison between FIGS. 7 (b) and (d) shows that a PSMZI device 100 using ACs 105 can be designed to have a lower cross-talk at the TX band compared to a PSMZI device using SCs.

The technique to shape the coupling coefficient K of an AC 105 is specifically as follows. Firstly, on a standard platform, the structural parameters (e.g. coupler waveguide width, waveguide length, gap width) of a SC, with a coupling coefficient K being reasonably close to the optimal value, are obtained. Secondly, using this SC design as a starting point, the three crucial structural parameters (i.e. coupler waveguide width w, waveguide width difference δw, gap width δx, as show in FIG. 5) of an AC 105, such as for example an LSST type AC, are obtained. This may advantageously be done by parametrical optimization, and in order to bring K as close as possible to the optimal value (i.e. the optimal coupling coefficient).

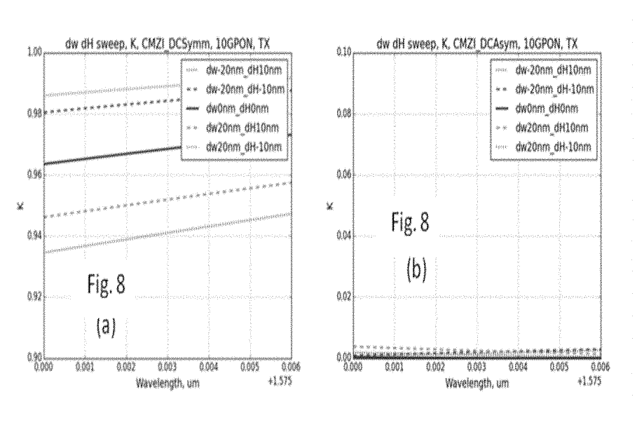

The present invention can also be applied to 10GPON applications. In this respect, FIG. 8(a) and FIG. 8(b) show simulated coupling coefficients K over the TX wavelength band of (a) a single SC, and (b) a single AC 105 as used in a PSMZI device 100 for a 10GPON duplexer application.

FIG. 8(a) and FIG. 8(b) also shows fabrication tolerances in respect to waveguide width (dw) and height (dH). The solid curves are the target design. The dotted lines correspond to a coupler with a waveguide width error of dw=−20 nm and a waveguide height error of dH=10 nm, and respectively with dw=20 nm and dH=−10 nm. The dashed lines correspond to dw=−20 nm and dH=−10 nm, and respectively to dw=20 nm and dH=10 nm.

Ideally, K should be equal to 0 or 1 at a wavelength of 1.578 μm (i.e. the 10GPON TX band central wavelength). The comparison between FIGS. 12 (a) and (b) shows that the ACs 105 can be designed to have a coupling coefficient K with a value closer to the ideal design than the SCs, while at the same time having a lower sensitivity to the waveguide dimension errors (dw, dH) at the TX band.

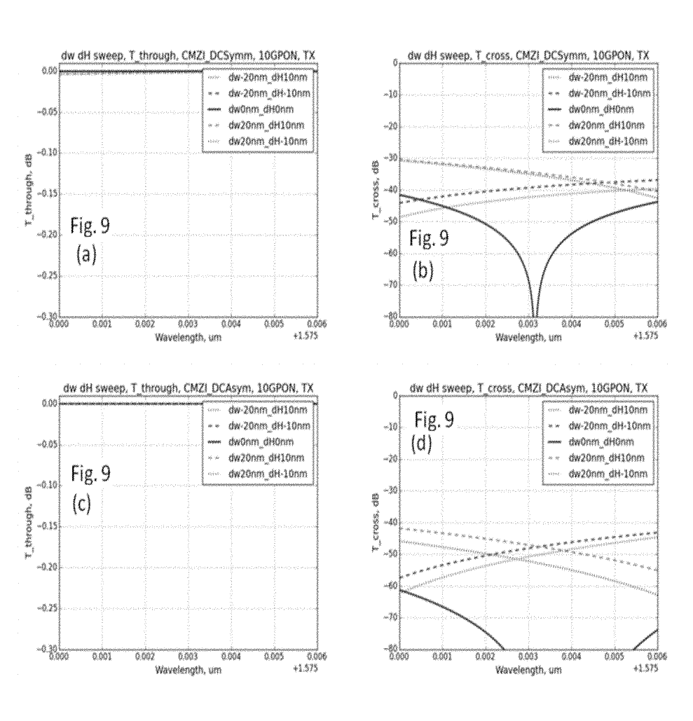

FIG. 9(a) and FIG. 9(b) and FIG. 9(c) and FIG. 9(d) show simulated CROSS/THROUGH port transmission spectra of a PSMZI device using SCs and of a PSMZI device 100 using ACs 105 at the 10GPON TX wavelength band. FIG. 9 (a) relates to the THROUGH port (TX insertion loss) with SCs. FIG. 9 (b) relates to the CROSS port (TX to RX cross talk) with SCs. FIG. 9 (c) relates to the THROUGH port 302 (TX insertion loss) with ACs 105. FIG. 9 (d) relates to the CROSS port 303 (TX to RX cross talk) with ACs 105.

FIG. 9(a) and FIG. 9(b) and FIG. 9(c) and FIG. 9(d) also shows the fabrication tolerances in respect to waveguide width (dw) and height (dH). The solid curves correspond to the target design. The dotted lines correspond to couplers with a waveguide width error of dw=−20 nm and a waveguide height error of dH=10 nm, and respectively with dw=20 nm and dH=−10 nm. The dashed lines correspond to dw=−20 nm and dH=−10 nm, and respectively to dw=20 nm and dH=10 nm.

The comparison between FIGS. 9 (a) and (c) shows that a PSMZI device 100 using ACs 105 can be designed to have a lower insertion loss, and a better fabrication tolerance, at the TX band compared to a PMSZI device using SCs. The comparison between FIGS. 9 (b) and (d) shows that a PSMZI device 100 using ACs 105 can be designed to have lower cross-talk at the TX band compared to a PSMZI device using SCs.

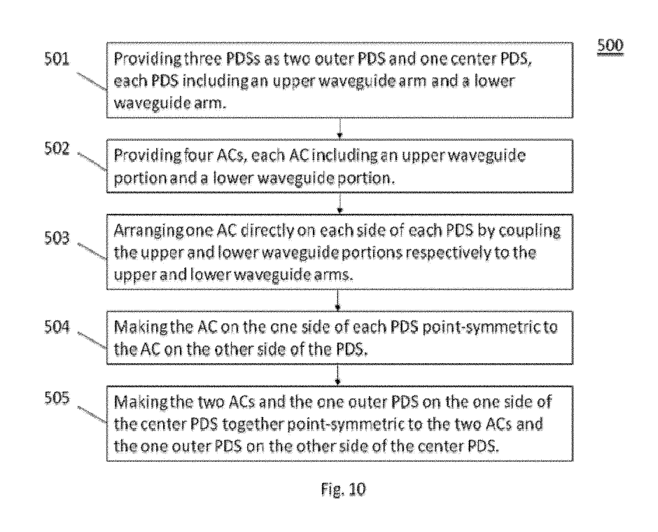

FIG. 10 shows a method 500 of fabricating a PSMZI device 100 described above. In particular, in a step 501, the three consecutive PDSs 101, 102 are provided as the two outer PDS 102 and the one center PDS 101. Each PDS 101, 102 includes an upper waveguide arm 103 and a lower waveguide arm 104. In a further step 502, the four ACs 105 are provided, each AC 105 including an upper waveguide portion 106 and a lower waveguide portion 107.

In particular, the steps 501 and 502 include a step 503, in which one AC 105 is arranged directly on each side of each PDS 101, 102, the upper and lower waveguide portions 106, 107 being respectively coupled to the upper and lower waveguide arms 103, 104. Thereby, a step 504 ensures that the AC 105 on the one side of each PDS 101, 102 is point-symmetric to the AC 105 on the other side of the PDS. Another step 505 ensures that the two ACs 105 and the one outer PDS 102 arranged on the one side of the center PDS 101 are together point-symmetric to the two ACs 105 and the one outer PDS 102 arranged on the other side of the center PDS 101.

In the method 500, the ACs 105 and PDS 101, 102 can be fabricated before arranging them all in the point-symmetric and consecutive order, or can be designed one after another in the consecutive order, or can be arranged in the consecutive order and finally shaped to become point symmetric.

In summary, a PSMZI device 100 according to an embodiment of the present invention, i.e. particularly the use of ACs 105 in this PSMZI device 100, results in much lower insertion loss in a TX (transmitter) wavelength band, and in much lower TX to RX (receiver) cross-talk in a TX wavelength band. This also means that the PSMZI device 100 can be fabricated without an anti-reflection coating (ARC) step. As a consequence, production costs are saved and the process flow is simplified. Additionally, the PSMZI device 100 is much less sensitive to fabrication errors, and offers a larger flexibility in its design.

The present invention has been described in conjunction with various embodiments as examples as well as implementations. However, other variations can be understood and effected by those persons skilled in the art and practicing the claimed invention, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. A point-symmetric Mach-Zehnder-Interferometer (PSMZI) device, comprising:
three consecutive path delay sections (PDSs) provided as two outer PDSs and one center PDS, each PDS comprising an upper waveguide arm and a lower waveguide arm;
four asymmetric couplers (ACs) each comprising an upper waveguide portion and a lower waveguide portion;
wherein one AC is arranged directly on each side of each PDS, the upper and lower waveguide portions being respectively coupled to the upper and lower waveguide arms;
wherein the AC on the one side of the PDS is point-symmetric to the AC on the other side of the PDS, and
wherein the two ACs and the one outer PDS arranged on the one side of the center PDS are together point-symmetric to the two ACs and the one outer PDS arranged on the other side of the center PDS.

2. A PSMZI device according to claim 1, wherein the center PDS provides a path difference of zero.

3. A PSMZI device according to claim 1, wherein a path difference provided by one outer PDS is the same, but is provided in the other waveguide arm, than a path difference provided by the other outer PDS.

4. A PSMZI device according to claim 1, wherein a total path length of all upper waveguide arms is the same as a total path length of all lower waveguide arms.

5. A PSMZI device according to claim 1, wherein the four ACs and the two outer PDS are designed such that a phase difference, which is caused by the two ACs and one outer PDS arranged on the one side of the center PDS, is compensated by a phase difference, which is caused by the two ACs and one outer PDS arranged on the other side of the center PDS.

6. A PSMZI device according to claim 1, wherein the four ACs are line-symmetric series-tapered (LSST) type.

7. A PSMZI device according to claim 1, wherein the waveguide arms are made of a material having a refractive index in a range of 1.4-4.5.

8. A PSMZI device according to claim 1, wherein the waveguide arms are made of SiN and are embedded into a cladding made of SiO₂.

9. A PSMZI device according to claim 1, further comprising:
an even number of additional PDSs provided on either side of and point-symmetrically to the center PDS, each additional PDS comprising an upper waveguide arm and a lower waveguide aim;
an even number of additional ACs or symmetric couplers (SCs) each comprising an upper waveguide portion and a lower waveguide portion;
wherein one AC or SC is arranged directly on each side of each additional PDS, the upper and lower waveguide portions being respectively coupled to the upper and lower waveguide aims; and
wherein the AC or SC on the one side of the additional PDS is point-symmetric to the AC or SC on the other side of the additional PDS.

10. A PSMZI device according to claim 1, wherein a width of each waveguide portion of each AC is between 1-3 μm.

11. A PSMZI device according to claim 1, wherein a width variation of each waveguide portion of each AC is between 10-1000 nm.

12. A PSMZI device according to claim 1, wherein a distance between the waveguide portions of each AC is between 0.25-0.5 μm.

13. A PSMZI device according to claim 1, further comprising:
two coupler Mach Zehnder Interferometers (MZIs) arranged in a point-symmetric way, and wherein coupling coefficients C(λ) of each coupler MZI satisfy C=0.5 at a peak transmission wavelength of a cross-port of the coupler MZI, C=0 or C=1 at a peak transmission wavelength of a through-port of the coupler MZI, and dC/dλ=0 at the peak transmission wavelength of the cross-port.

14. A wavelength duplexer device comprising:
at least one PSMZI device according to claim 1; and
the wavelength duplexer device is configured for use in a passive optical network (PON) related application.

15. A method of fabricating a point-symmetric Mach-Zehnder Interferometer (PSMZI) device, the method comprising:
providing three consecutive path delay sections (PDSs) as two outer PDSs and one center PDS, each PDS comprising an upper waveguide arm and a lower waveguide arm;
providing four asymmetric couplers (ACs) each comprising an upper waveguide portion and a lower waveguide portion;
wherein one AC is arranged directly on each side of each PDS, the upper and lower waveguide portions being respectively coupled to the upper and lower waveguide arms;
wherein the AC on the one side of the PDS is point-symmetric to the AC on the other side of the PDS; and
wherein the two ACs and the one outer PDS arranged on the one side of the center PDS are together point-symmetric to the two ACs and the one outer PDS arranged on the other side of the center PDS.
